(19) United States
(12) Patent Application Publication
(10) Pub. No.: US 2006/0259815 A1
(43) Pub. Date: Nov. 16, 2006

(54) Systems and methods for ensuring high availability

(75) Inventors: Simon Graham, Bolton, MA (US); Dan Lussier, Holliston, MA (US)

Correspondence Address: KIRKPATRICK & LOCKHART NICHOLSON GRAHAM LLP, STATE STREET FINANCIAL CENTER, ONE LINCOLN STREET, BOSTON, MA, 02111-2950, US

(73) Assignee: Stratus Technologies Bermuda Ltd., Hamilton (BM)

(21) Appl. No.: 11/125,884

(22) Filed: May 10, 2005

(51) Int. Cl. G06F 11/00

(52) U.S. Cl. 714/11

(57) ABSTRACT

A highly-available computer system is provided. The system includes at least two computer subsystems, each including memory, a local storage device and an embedded operating system. The system also includes a communication link between the two subsystems. Upon the initialization of the two computer subsystems, the embedded operating systems communicate via the communications link and designate one of the two subsystems as dominant. The dominant subsystem then loads a primary operating system. As write operations are sent to the local storage device of the dominant system, the write operations are mirrored over the communications link to each subservient system's local storage device. In the event of a failure of the dominant system, a subservient system will automatically become dominant and continue providing services to end-users.

### FIELD OF THE INVENTION

The present invention relates generally to computers and, more specifically, to highly available computer systems.

### BACKGROUND

Computers are used to operate critical applications for millions of people every day. These critical applications may include, for example, maintaining a fair and accurate trading environment for financial markets, monitoring and controlling air traffic, operating military systems, regulating power generation facilities and assuring the proper functioning of life-saving medical devices and machines. Because of the mission-critical nature of applications of this type, it is crucial that their host computer remain operational virtually all of the time.

Despite attempts to minimize failures in these applications, the computer systems still occasionally fail. Hardware or software glitches can retard or completely halt a computer system. When such events occur on typical home or small-office computers, there are rarely life-threatening ramifications. Such is not the case with mission-critical computer systems. Lives can depend upon the constant availability of these systems, and therefore there is very little tolerance for failure.

In an attempt to address this challenge, mission-critical systems employ redundant hardware or software to guard against catastrophic failures and provide some tolerance for unexpected faults within a computer system. As an example, when one computer fails, another computer, often identical in form and function to the first, is brought on-line to handle the mission critical application while the first is replaced or repaired.

Exemplary fault-tolerant systems are provided by Stratus Technologies International of Maynard, Mass. In particular, Stratus' ftServers provide better than 99.999% availability, being offline only two minutes per year of continuous operation, through the use of parallel hardware and software typically running in lockstep. During lockstep operation, the processing and data management activities are synchronized on multiple computer subsystems within an ftServer. Instructions that run on the processor of one computer subsystem generally execute in parallel on another processor in a second computer subsystem, with neither processor moving to the next instruction until the current instruction has been completed on both. In the event of a failure, the failed subsystem is brought offline while the remaining subsystem continues executing. The failed subsystem is then repaired or replaced, brought back online, and synchronized with the still-functioning processor. Thereafter, the two systems resume lockstep operation.

Though running computer systems in lockstep does provide an extremely high degree of reliability and fault-tolerance, it is typically expensive due to the need for specialized, high quality parts as well as the requisite operating system and application licenses for each functioning subsystem. Furthermore, while 99.999% availability may be necessary for truly mission critical applications, many users can survive with a somewhat lower ratio of availability, and would happily do so if the systems could be provided at lower cost.

### SUMMARY OF THE INVENTION

Therefore, there exists a need for a highly-available system that can be implemented and operated at a significantly lower cost than those required for applications that are truly mission-critical. The present invention addresses these needs, and others, by providing a solution comprising redundant systems that utilize lower-cost, off-the-shelf components. The present invention therefore provides a highly-available cost-effective system that still maintains a reasonably high level of availability and minimizes down time for any given failure.

In one aspect of the present invention, a highly-available computer system includes at least two computer subsystems, with each subsystem having memory, a local storage device and an embedded operating system. The system also includes a communications link connecting the subsystems (e.g., one or more serial or Ethernet connections). Upon initialization, the embedded operating systems of the subsystems communicate via the communications link and designate one of the subsystems as dominant, which in turn loads a primary operating system. Any non-dominant subsystems are then designated as subservient. In some embodiments, the primary operating system of the dominant subsystem mirrors the local storage device of the dominant subsystem to the subservient subsystem (using, for example, Internet Small Computer System Interface instructions).

In some embodiments, a computer status monitoring apparatus instructs the dominant subsystem to preemptively reinitialize, having recognized one or more indicators of an impending failure. These indicators may include, for example, exceeding a temperature threshold, the reduction or failure of a power supply, or the failure of mirroring operations.

In another aspect of the present invention, embedded operating system software is provided. The embedded operating system software is used in a computer subsystem, the system having a local memory and a local storage device. The software is configured to determine whether or not the subsystem should be designated as a dominant subsystem during the subsystem's boot sequence. The determination is based on communications with one or more other computer subsystems. In the event that the subsystem is designated as a dominant subsystem, it loads a primary operating system into its memory. If it not designated as dominant, however, it is designated as a subservient subsystem and forms a network connection with a dominant subsystem. In addition to forming a network connection with a dominant subsystem, the now subservient subsystem also stores data received through the network connection from the dominant subsystem within its storage device.

In another aspect of the present invention, a method of achieving high availability in a computer system is provided. The computer system includes a first and second subsystem connected by a communications link, with each subsystem typically having a local storage device. Each subsystem, during their respective boot sequences, loads an embedded operating system. It is then determined, between the subsystems, which subsystem is the dominant subsystem and which is subservient. The dominant system then loads a primary operating system and copies write operations directed to its local storage device to the subservient subsystem over the communications link. The write operations are then committed to the local storage device of each subsystem. This creates a general replica of the dominant subsystem's local storage device on the local storage device of the subservient subsystem.

In another aspect of the present invention, a computer subsystem is provided. The computer subsystem typically includes a memory, a local storage device, a communications port, and an embedded operating system. In this aspect the embedded operating system is configured to determine if the subsystem is a dominant subsystem upon initialization. If the subsystem is a dominant subsystem, the subsystem is configured to accesses a subservient subsystem and further configured to mirror write operations directed to the dominant subsystem's local storage device to the subservient system.

Other aspects and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other objects, features, and advantages of the present invention, as well as the invention itself, will be more fully understood from the following description of various embodiments, when read together with the accompanying drawings, in which:

FIG. 1 is a block diagram depicting a highly-available computer system in accordance with one embodiment of the present invention;

FIG. 2 is a block diagram depicting the subsystems of FIG. 1 after one subsystem has been designated as dominant;

FIG. 3 is a flow chart illustrating the operation of the preferred embodiment; and

FIG. 4 illustrates a range of possible tests to determine whether or not a subsystem has failed.

### DETAILED DESCRIPTION

As discussed previously, traditional lockstep computing is not cost-effective for every computer system application. Typically, lockstep computing involves purchasing expensive, high-quality hardware. While such architectures can provide virtually 100% availability, many applications do not perform functions that require such a high degree of reliability. The present invention provides computer systems and operating methods that deliver a level of availability sufficient for a majority of computer applications while using less expensive, readily-available computer subsystems.

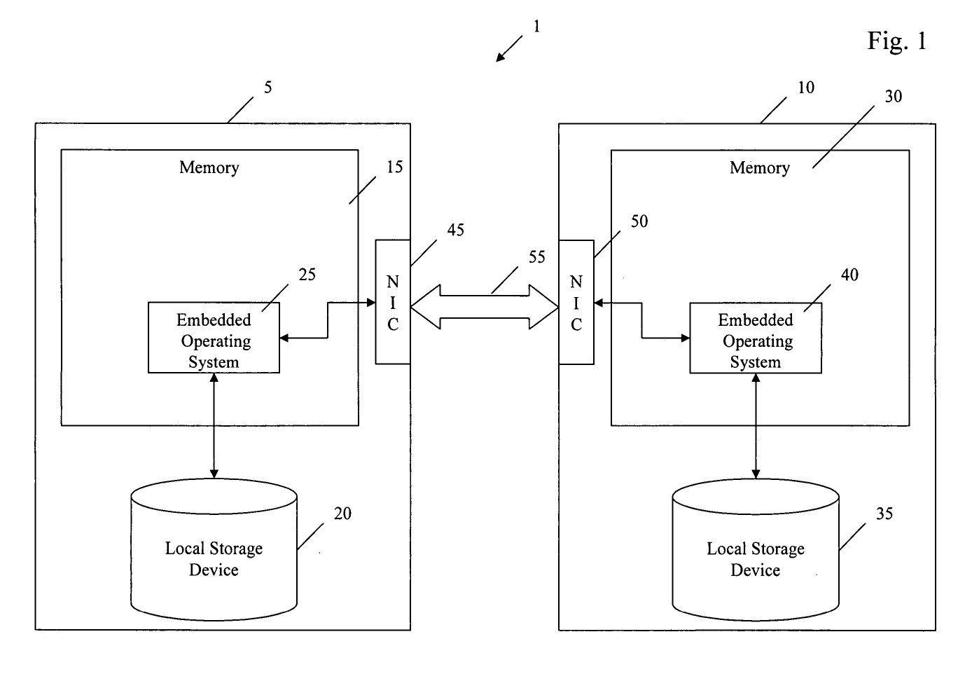

FIG. 1 is a block diagram depicting a highly-available computer system 1 in accordance with one embodiment of the present invention. As illustrated, the highly-available computer system 1 includes two subsystems 5, 10, however the system 1 may include any number of subsystems greater than two. The first subsystem 5 includes a memory 15, a local storage device 20 and an embedded operating system 25. The second computer subsystem 10 likewise includes a memory 30, a local storage device 35 and an embedded operating system 40. The memory devices 15, 30 may comprise, without limitation, any form of random-access memory or read-only memory, such as static or dynamic read only memory, or the like. Preferably, each subsystem 5, 10 includes a Network Interface Card (NIC) 45, 50, with a communications link 55 connecting the computer subsystems 5, 10 via their respective NICs 45, 50. This communications link 55 may be an Ethernet connection, fibre channel, PCI Express, or other high-speed network connection.

Preferably, upon initialization, the embedded operating systems 25, 40 are configured to communicate via the communications link 55 in order to designate one of the computer subsystems 5, 10 as dominant. In some embodiments, designating one subsystem as dominant is determined by a race condition, wherein the first subsystem to assert itself as dominant becomes dominant. In one version, this may include checking for a signal upon initialization that another subsystem is dominant and, if no such signal has been received, sending a signal to other subsystems that the signaling subsystem is dominant. In another version of the embodiment, where a backplane or computer bus connects the subsystems 5, 10, the assertion of dominance involves checking a register, a hardware pin, or a memory location available to both subsystems 5, 10 for an indication that another subsystem has declared itself as dominant. If no such indication is found, one subsystem asserts its role as the dominant subsystem by, e.g., placing a specific data in the register or memory or asserting a signal high or low on a hardware pin.

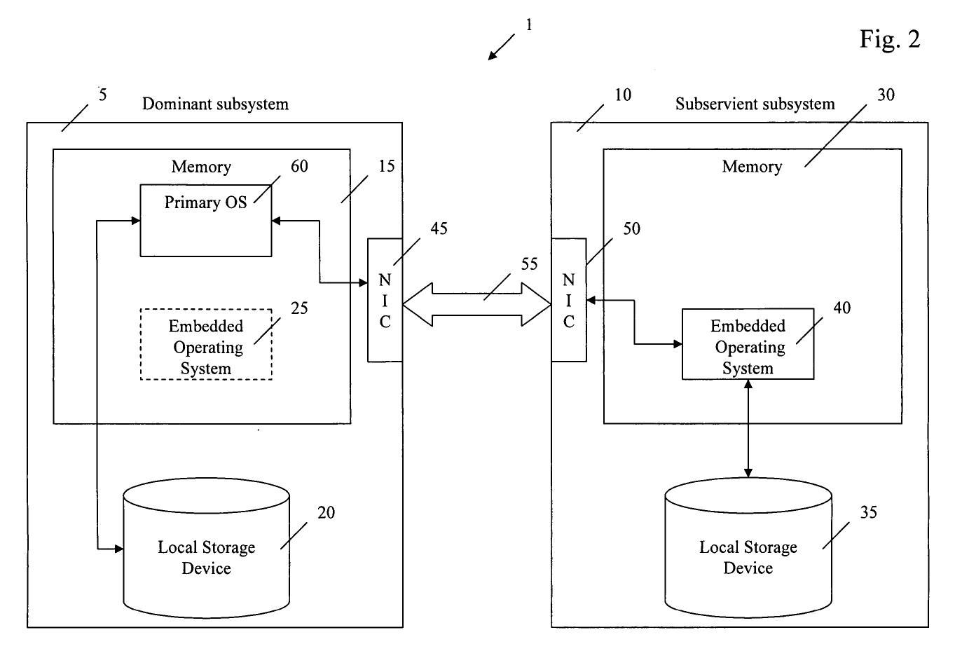

FIG. 2 depicts the subsystems 5, 10 of FIG. 1 after subsystem 5 has been designated as dominant. After subsystem 5 is designated as dominant, in some embodiments, the dominant subsystem 5 loads a primary operating system 60 into memory 15. The primary operating system 60 may be a Microsoft Windows-based operating system, a Gnu/Linux-based operating system, a UNIX-based operating system, or any derivation of these. The primary operating system 60 is configured to mirror the local storage device 20 of the dominant subsystem 5 to the local storage device 35 of any subservient subsystems. Mirroring is typically RAID 1 style mirroring, e.g., data replication between mirror sides, but other mirroring schemes, e.g., mirroring with parity, are used in some embodiments. In some embodiments, the local storage device 20 of the dominant subsystem 5 is mirrored using the Internet Small Computer System Interface (iSCSI) protocol over the communications link 55.

Preferably, the embedded operating system 25 becomes dormant, or inactive, once the primary operating system 60 is booted. Accordingly, the inactive embedded operating system 25 is illustrated in shadow in FIG. 2. Advantageously, because only one subsystem is dominant at any one time, only one copy of the primary operating system 60 needs to be loaded. Thus, only one license to operate the primary operating system 60 is required for each fault-tolerant system.

In a preferred embodiment, mirroring is achieved by configuring the primary operating system 60 to see the local storage device 35 in the subservient system 10 as an iSCSI target and by configuring RAID mirroring software in the primary operating system 60 to mirror the local storage device 20 of the dominant subsystem 5 to this iSCSI target.

In one embodiment, the subsystems 5, 10 are configured to reinitialize upon a failure of the dominant subsystem 5. In an alternate embodiment, only the dominant subsystem 5 is configured to reinitialize upon a failure. If the dominant system 5 fails to successfully reinitialize after a failure, it can be brought offline, and a formerly subservient subsystem 10 is designated as dominant.

There are many indications that the dominant subsystem 5 has failed. One indication is the absence of a heartbeat signal being sent to each subservient subsystem 10. The heartbeat protocol is typically transmitted and received between the embedded operating system 25 of the dominant subsystem 5 and the embedded operating system 40 of the subservient subsystem 10. In alternate embodiments, the dominant subsystem 5 is configured to send out a distress signal, as it is failing, thereby alerting each subservient subsystem 10 to the impending failure of the dominant subsystems.

In one embodiment, the subsystems 5, 10 communicate over a backplane and each subsystem 5, 10 is in signal communication with a respective Baseboard Management Controller (BMC, not shown). The BMC is a separate processing unit that is able to reboot subsystems and/or control the electrical power provided to a given subsystem. In other embodiments, the subsystems 5, 10 are in communication with their respective BMCs over a network connection such as an Ethernet, serial or parallel connection. In still other embodiments, the connection is a management bus connection such as the Intelligent Platform Management Bus (IPMB also known as I2C/MB). The BMC of the dominant subsystem 5 may also be in communication with the BMC of the subservient subsystem 10 via another communications link 55. In other embodiments, the communications link of the BMCs comprises a separate, dedicated connection.

Upon the detection of a failure of the dominant subsystem 5 by the subservient subsystem 10, the subservient subsystem 10 transmits instructions, via its BMC, to the BMC of the dominant subsystem 5, that the dominant subsystem 5 needs to be rebooted or, in the event of repeated failures, (e.g., after one or more reboots) taken offline.

In the preferred embodiment, a failure of one subsystem may be predicted by a computer status monitoring apparatus (not shown) or by the other subsystem. For example, where the subsystems 5, 10 monitor each other, the dominant subsystem 5 monitors the health of the subservient 10 and the subservient subsystem 10 monitors the health of the dominant subsystem 5. In embodiments where the monitoring apparatus reports subsystem health, the monitoring apparatus typically runs diagnostics on the subsystems 5, 10 to determine their status. It may also instruct the dominant subsystem 5 to preemptively reinitialize if certain criteria infer that a failure of the dominant subsystem is likely. For example, the monitoring apparatus may predict the dominant subsystem's failure if the dominant subsystem 5 has exceeded a specified internal temperature threshold. Alternatively, the monitoring apparatus may predict a failure because the power to the dominant subsystem 5 has been reduced or cut or an Uninterrupted Power Supply (UPS) connected to the dominant subsystem has failed. Additionally, the failure of the dominant subsystem 5 to accurately mirror the local storage 20 to the subservient subsystem 10, may also indicate an impending failure of the dominant subsystem 5.

Other failures may trigger the reinitialization of one or more subsystems 5, 10. In some embodiments, the subsystems 5, 10 may reinitialize if the dominant subsystems 5 fails to load the primary operating system 60. The subsystems may further be configured to remain offline if the dominant subsystem fails to reinitialize after the initial failure. In these scenarios, the subservient subsystem 10 may designate itself as the dominant subsystem and attempt reinitialization. If the subservient subsystem 10 fails to reinitialize, both subsystems 5, 10 may remain offline until a system administrator attends to them.

The subsystems 5, 10 can also selectively reinitialize themselves based on the health of the subservient subsystem 10. In this case, the dominant subsystem 5 does not reinitialize, only the subservient subsystem 10 does. Alternatively, the subservient subsystem 10 may remain offline until a system administrator can replace the offline subservient subsystem 10.

Preferably, each rebooting subsystem 5, 10 is configured to save its state information before reinitialization. This state information may include the data in memory prior to a failure or reboot, instructions leading up to a failure, or other information known to those skilled in the art. This information may be limited in scope or may constitute an entire core dump. The saved state information may be used later to analyze a failed subsystem 5, 10, and may also be used by the subsystems 5, 10 upon reinitialization.

Finally, the dominant 5 and subservient 10 subsystems are preferably also configured to coordinate reinitialization by scheduling it to occur during a preferred time such as a scheduled maintenance window. Scheduling time for both systems to reinitialize allows administrators to minimize the impact that system downtime will have on users, thus allowing the reinitialization of a subsystem or a transfer of dominance from one subsystem to another occur gracefully.

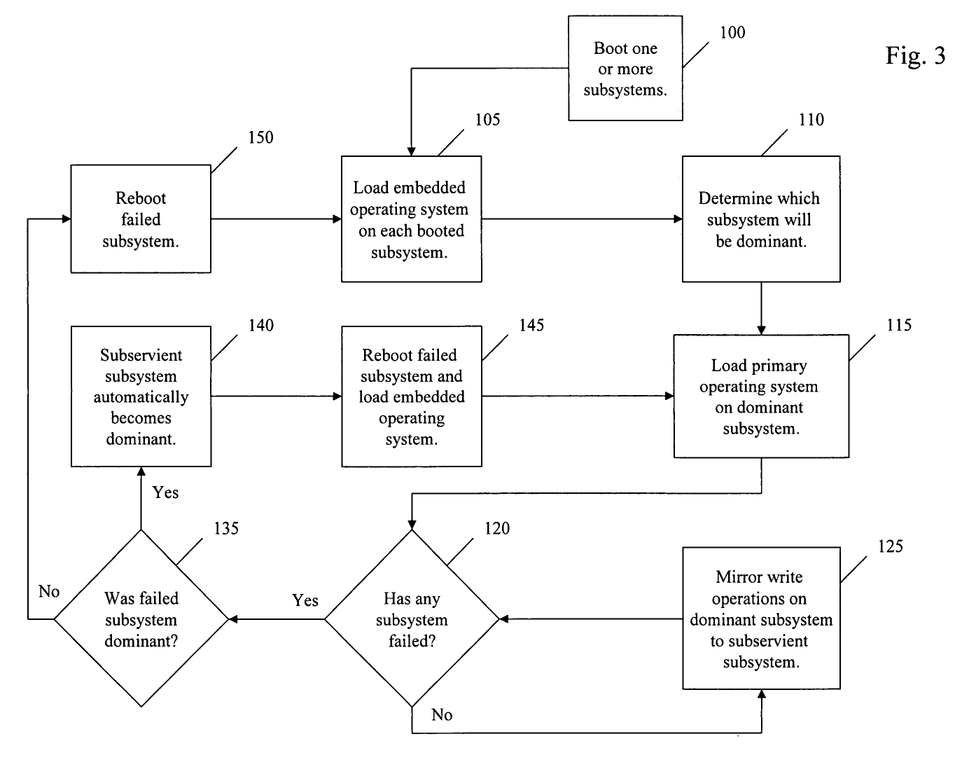

FIG. 3 is a flow chart illustrating the operation of the preferred embodiment. Initially, each subsystem 5, 10 is powered on or booted (step 100). As before, although only two subsystems 5, 10 are illustrated in FIGS. 1 and 2, any number of subsystems greater than two may be used. Next, the embedded operating systems 25, 40 are loaded (step 105) onto each booted subsystem 5, 10 during their respective initializations.

At this point, one of the subsystems 5, 10 is then designated as the dominant subsystem (step 110). In some embodiments, dominance is determined through the use of one or more race conditions, as described above. Dominance may be determined by assessing which computer subsystem completes its initialization first, or which subsystem is able to load the primary operating system 60 first. Again, for this example, the subsystem designated as dominant will be subsystem 5. Once it is determined which subsystem will be dominant, the dominant subsystem 5 loads (step 115) a primary operating system 60.

After loading (step 115) the primary operating system on the dominant subsystem 5, a determination is made (step 120) if any subsystem 5, 10 has failed, according to the procedure described below. If no failure is detected, writes being processed by the dominant subsystem 5 are mirrored (step 125) to the subservient subsystem 10. Typically the dominant subsystem 5 mirrors (step 125) its write operations to the subservient subsystem 10. Specifically, all disk write operations on the dominant subsystem 5 are copied to each subservient subsystem 10. In some embodiments, the primary operating system 60 copies the writes by using a mirrored disk interface to the two storage devices 20, 35. Here, the system interface for writing to the local storage device 20 is modified such that the primary operating system 60 perceives the mirrored storage devices 20, 35 as a single local disk, i.e., it appears as if only the local storage device 20 of the dominant subsystem 5 existed. In these versions, the primary operating system 60 is unaware that write operations are being mirrored (step 125) to the local storage device 35 of the second subsystem 10. In some versions, the mirroring interface depicts the local storage device 35 of the second subsystem 10 as a second local storage device on the dominant subsystem 5, the dominant subsystem 5 effectively treating the storage device 35 as a local mirror. In other versions, the primary operating system 60 treats the local storage 35 of the second subsystem 10 as a Network Attached Storage (NAS) device and the primary operating system 60 uses built-in mirroring methods to replicate writes to the local storage device 35 of the subservient subsystem 10.

Typically, the primary operating system 60 mirrors the write operations that are targeting the local storage device 20, however in some embodiments the embedded operating system 25 acts as a disk controller and is responsible for mirroring the write operations to the local storage device 35 of the subservient subsystem 10. In these embodiments, the embedded operating system 25 can perform the function of the primary operating system 60 as described above, i.e., presenting the storage devices 20, 35 as one storage device to the primary operating system and mirroring write I/Os transparently or presenting the local storage device 35 of the subservient subsystem as a second storage device local to the dominant subsystem 5.

In alternate embodiments, while write operations are mirrored from the dominant subsystem 5 to each subservient subsystem 10 (step 125), diagnostic tools could be configured to constantly monitor the health of each subsystem 5, 10 to determine whether or not it has failed. As described above, these diagnostics may be run by a monitoring apparatus or by the other subsystem. For example, the dominant subsystem 5 could check the health of the subservient subsystem 10, the subservient subsystem 10 may check the health of the dominant subsystem 5, or in some cases each subsystem 5, 10 may check its own health as a part of one or more self-diagnostic tests.

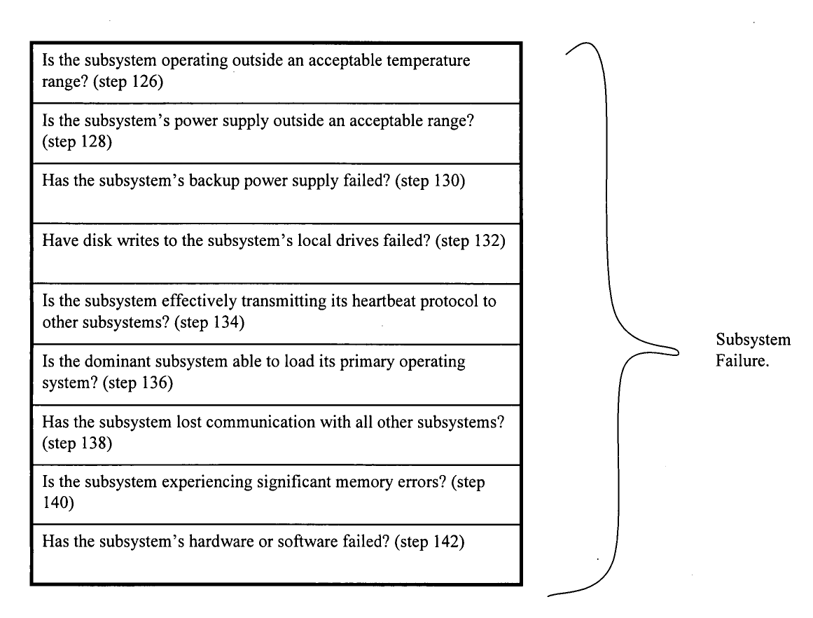

FIG. 4 illustrates a range of possible tests to determine whether or not a subsystem has failed during step 120. In essence, a subsystem will be deemed to have failed if one or more of the following conditions is true:

The subsystem is operating outside an acceptable temperature range. (step 126)

The subsystem's power supply is outside an acceptable range. (step 128)

The subsystem's backup power supply has failed. (step 130)

Disk writes to the subsystem's local drives have failed. (step 132)

The subsystem is not effectively transmitting its heartbeat protocol to other subsystems. (step 134)

The subsystem has been deemed dominant, but is not able to load its primary operating system. (step 136)

The subsystem has lost communication with all other subsystems. (step 138)

The subsystem is experiencing significant memory errors. (step 140)

The subsystem's hardware or software has failed. (step 142)

More specifically, the dominant subsystem 5 is continually monitored (step 126) to determine if it is operating within a specified temperature range. A test may also be run to determine (step 128) if the dominant subsystem 5 is receiving power that falls within an expected range—e.g., that the power supply of the dominant subsystem 5 is producing a sufficient wattage, that the dominant subsystem 5 is receiving enough power from an outlet or other power supply. If the dominant subsystem 5 is receiving enough power, then a test is performed to determine (step 130) if a back up power supply, e.g., an UPS unit, is operating correctly. If so, it is determined (step 132) if the write operations to the local storage device 20 are being properly committed. Additionally, this test may incorporate a secondary test to determine that disk write operations are correctly being mirrored to the local storage device 35 of the subservient subsystem 10. Furthermore, a check is performed to detect (step 134) if the dominant subsystem is participating in the heartbeat protocol. If the subsystem is dominant, the accuracy of the dominant subsystem's 5 load and execution of the primary operating system 60 is confirmed (step 136), and a determination is made (step 138) if the communications link 55 is still active between the dominant 5 and subservient 10 subsystems. If the communications link 55 is still active, the subsystem checks (step 140) if any memory errors that may have occurred are correctable. If so, it is determined (step 142) if any hardware or software may have failed.

If these tests all succeed, then the present invention continues as before, mirroring (step 125) write operations to the local storage device 35 of each subservient subsystem 10. If any of these tests fail however, the present invention checks (step 135) if the failed system was dominant.

Referring back to FIG. 3, in. Step 120, each subsystem 5, 10 determines whether or not it has failed, according to the procedure described above. As long as no subsystem 5, 10 has failed, writes are mirrored from the dominant subsystem 5, to each subservient subsystem 10. Thus, each subservient subsystem 10 maintains its own copy of everything stored on the dominant subsystem 5, to be used in the event that the dominant subsystem 5 fails.

If any subsystem fails (step 120), an assessment is quickly made as to whether the failed subsystem was dominant or subservient (step 135). If the failed subsystem was subservient, then the system proceeds normally, with any other available subservient subsystems continuing to receive a mirrored copy of the dominant subsystem's 5 written data. In that case, the failed subservient subsystem may be rebooted (step 150), and may reconnect to the other subsystems in accordance with the previously described procedures. Optionally, an administrator may be notified that the subservient subsystem 10 has failed, and should be repaired or replaced.

If, however, the failed subsystem was dominant, a formerly subservient system will immediately be deemed dominant. In that case, the failed dominant subsystem will reboot (step 145) and the new dominant subsystem will load the primary operating system (step 115). After loading the primary operating system, the new dominant subsystem will mirror its data writes to any connected subservient subsystems. If there are no connected subservient subsystems, the new dominant subsystem will continue operating in isolation, and optionally will alert an administrator with a request for assistance.

In the event that both subsystems 5, 10 have failed, or if the communications link 55 is down after rebooting (steps 145, 150), typically both systems remain offline until an administrator tends to them. It should be noted that in the scenario where the failed subsystem was dominant, the subservient subsystem, upon becoming dominant, may not necessarily wait for the failed subsystem to come online before loading the primary operating system. In these embodiments, if the failed (previously dominant) subsystem remains offline, and if there are no other subservient subsystems connected to the new dominant subsystem, the new dominant subsystem proceeds to operate without mirroring write operations until the failed subsystem is brought back online.

From the foregoing, it will be appreciated that the systems and methods provided by the invention afford a simple and effective way of mirroring write operations over a network using an embedded operating system. One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A highly-available computer system comprising:
a first computer subsystem, comprising a first memory, a first local storage device and a first embedded operating system;
a second computer subsystem, comprising a second memory, a second local storage device and a second embedded operating system; and
a communications link connecting the first and second computer subsystems,
wherein, upon initialization, the first and second embedded operating systems are configured to communicate via the communications link in order to designate one of the first and second computer subsystems as dominant.

2. The computer system of claim 1, wherein the first and second embedded operating systems are configured to communicate via the communications link in order to designate the non-dominant computer subsystem as subservient.

3. The computer system of claim 2, wherein the dominant subsystem is configured to load a primary operating system.

4. The computer system of claim 3, wherein the primary operating system of the dominant subsystem is configured to mirror the local storage device of the dominant subsystem to the local storage device of the subservient subsystem.

5. The computer system of claim 4, wherein the dominant subsystem is configured to mirror the local storage device of the dominant subsystem through the use of Internet Small Computer System Interface (iSCSI) instructions.

6. The computer system of claim 1, wherein the communications link comprises an Ethernet connection.

7. The computer system of claim 1, wherein the communications link comprises a redundant Ethernet connection comprising at least two separate connections.

8. The computer system of claim 1, wherein each of the subsystems are configured to reinitialize upon a failure of the dominant subsystem.

9. The computer system of claim 8, wherein the subservient subsystem is designated as dominant if the dominant system fails to successfully reinitialize after failure.

10. The computer system of claim 8, wherein the dominant subsystem is deemed to have failed when it does not send a heartbeat signal.

11. The computer system of claim 1, wherein the dominant subsystem is reinitialized preemptively upon receipt of instructions from a computer status monitoring apparatus which predicts the dominant subsystem's imminent failure in response to one or more of the following:
the dominant subsystem has exceeded a specified internal temperature threshold;
power to the dominant subsystem has been reduced or cut;
an Uninterrupted Power Supply (UPS) connected to the dominant subsystem has failed; and
the dominant subsystem has failed to accurately mirror the local storage to the subservient subsystem.

12. The computer system of claim 11 wherein the dominant subsystem saves data to its local storage device prior to reinitialization.

13. The computer system of claim 11 wherein the dominant and subservient subsystems coordinate reinitialization by scheduling the reinitialization during a preferred time.

14. The computer system of claim 13 wherein the dominant and subservient subsystems further coordinate that upon reinitialization, the subservient subsystem will become dominant.

15. The computer system of claim 1, wherein the primary operating system is a Microsoft Windows-based operating system.

16. The computer system of claim 1, wherein the primary operating system is Linux.

17. Operating system software resident on a first computer subsystem, the first computer system having a local memory and a local storage device, the software configured to:
determine, during the first subsystem's boot sequence, if the first subsystem should be designated as a dominant subsystem, based upon communications with one or more other computer subsystems;
if the first subsystem is designated as the dominant subsystem, loading a primary operating system into the local memory; and
otherwise, designating the first subsystem as a subservient subsystem, forming a network connection with a dominant subsystem, and storing data received through the network connection and from the dominant subsystem within a storage device local to the subservient subsystem.

18. The software of claim 17, further configured to reinitialize the subservient subsystem if the dominant subsystem fails.

19. The software of claim 17, further configured to reinitialize the first subsystem to become the subservient subsystem if the first subsystem was the dominant subsystem and failed to load the primary operating system.

20. The software of claim 18, further configured to remain offline if the first subsystem was the dominant subsystem and fails to reinitialize after the failure.

21. The software of claim 18, further configured to designate the first subsystem as the dominant subsystem if the first subsystem was previously the subservient subsystem and the dominant subsystem fails to reinitialize after the failure.

22. The software of claim 17, further configured to preemptively reinitialize the dominant subsystem upon receipt of instructions from a computer status monitoring apparatus which predicts the dominant subsystem's imminent failure in response to one or more of the following:
the dominant subsystem has exceeded a specified internal temperature threshold;
power to the dominant subsystem has been reduced or cut;
an Uninterrupted Power Supply (UPS) connected to the dominant subsystem has failed; and
the dominant subsystem has failed to accurately mirror the local storage to the subservient subsystem.

23. The software of claim 22, further configured to save application data to the local storage device prior to reinitialization.

24. The software of claim 22, further configured to coordinate reinitialization of the dominant and subservient subsystems by scheduling the reinitialization during a preferred time

25. The software of claim 17, further configured to participate in a heartbeat protocol with the embedded operating system of a second subsystem.

26. A method of achieving high availability in a computer system comprising a first and second subsystem connected by a communications link, each subsystem having a local storage device, the method comprising:
loading an embedded operating system on each of the first and second subsystems during the boot sequence of the first and second subsystem;
determining which subsystem is the dominant subsystem;
loading a primary operating system on the dominant subsystem;
copying write operations directed at the local storage of the dominant subsystem to the subservient subsystem over the communications link; and
committing the write operations to the local storage device of each subsystem.

27. The method of claim 26, wherein upon a failure of the dominant subsystem, reinitializing both subsystems and designating, during the determining step, that the subservient subsystem becomes dominant.

28. A computer subsystem comprising:
a memory;
a local storage device;
a communications port; and
an embedded operating system configured to:
determine, upon initialization, if the subsystem is a dominant subsystem, such that should the subsystem be a dominant subsystem, the subsystem is configured to accesses a subservient subsystem; and further configured to
mirror write operations directed to the local storage device of the subsystem to the subservient system.

29. The subsystem of claim 28, the embedded operating system further configured such that if the subsystem is not the dominant subsystem, it becomes the subservient subsystem and receives write operations from the dominant subsystem.
